(19) United States
(12) Patent Application Publication
(10) Pub. No.: US 2025/0089813 A1
(43) Pub. Date: Mar. 20, 2025

(54) CHARGING DEVICE FOR AEROSOL GENERATING DEVICE AND CHARGING SYSTEM COMPRISING THE SAME

(71) Applicant: KT&G CORPORATION, Daejeon (KR)

(72) Inventors: Wonkyeong LEE, Guri-si (KR); Min Kyu KIM, Seoul (KR); Paul Joon SUNWOO, Seoul (KR)

(73) Assignee: KT&G CORPORATION, Daejeon (KR)

(21) Appl. No.: 18/569,472

(22) PCT Filed: Jun. 30, 2023
(86) PCT No.: PCT/KR2023/009186

§ 371 Date: Dec. 12, 2023

(30) Foreign Application Priority Data
Jul. 4, 2022 (KR) 10-2022-0081786

(51) Int. Cl. A24F 40/95

(52) U.S. Cl. CPC A24F 40/95

(57) ABSTRACT

A charging device for an aerosol generating device including a first charging pin and a second charging pin spaced apart from the first charging pin by a first interval includes a charging station on which a plurality of charging pads is arranged to be spaced apart from each other and a controller configured to detect, among the plurality of charging pads, one charging pad to which the first charging pin is connected and another charging pad to which the second charging pin is connected, and supply power to the detected charging pads, wherein two adjacent charging pads among the plurality of charging pads are spaced apart by a second interval that is less than or equal to the first interval.

### TECHNICAL FIELD

The following description relates to a charging device for an aerosol generating device and a charging system including the same.

### BACKGROUND ART

Recently, demands for alternative articles to overcome disadvantages of general cigarettes have increased. For example, there is an increasing demand for devices that generate an aerosol by electrically heating a cigarette stick (e.g., cigarette-like electronic cigarettes). Accordingly, research on an electrically heated aerosol generating device and a cigarette stick (or an aerosol generating article) applied thereto is being actively conducted.

### DISCLOSURE OF THE INVENTION

### Technical Goals

Various embodiments are to reduce restrictions on a charging connection of an aerosol generating device and a charging station. Embodiments are to provide an aerosol generating device that can be charged at any position on the charging station, in order to improve the charging convenience and the charging efficiency of the aerosol generating device.

### Technical Solutions

According to an embodiment, a charging device for an aerosol generating device including a first charging pin and a second charging pin spaced apart from the first charging pin by a first interval includes a charging station on which a plurality of charging pads is arranged to be spaced apart from each other and a controller configured to detect, among the plurality of charging pads, one charging pad to which the first charging pin is connected and another charging pad to which the second charging pin is connected, and supply power to the detected charging pads. In the charging station, two adjacent charging pads among the plurality of charging pads are spaced apart by a second interval that is less than or equal to the first interval.

In an embodiment, the plurality of charging pads may be arranged in a matrix structure along a first direction and a second direction perpendicular to the first direction.

In an embodiment, each of the plurality of charging pads may be formed in a planar structure having a first width in the first direction and a second width in the second direction.

In an embodiment, the second interval may corresponds to one of a first sub-interval between two charging pads adjacent in the first direction and a second sub-interval between two charging pads adjacent in the second direction. A sum of the first width and the first sub-interval may be less than or equal to the first interval.

In an embodiment, a sum of the second width and the second sub-interval may be less than or equal to the first interval.

In an embodiment, the charging station may include a guide member provided between the plurality of charging pads and configured to guide the first charging pin or the second charging pin to an adjacent charging pad.

In an embodiment, the guide member may include a plurality of protrusions spaced apart at a predetermined interval on a surface on which the plurality of charging pads are arranged.

In an embodiment, the guide member may have a shape in which a cross-sectional area tapers off towards a protruding direction.

In an embodiment, at least a partial area of the guide member may be made of an insulating material.

In an embodiment, the charging station may include a supporting member configured to support a side surface of the aerosol generating device.

In an embodiment, the charging station may include a charging surface on which the plurality of charging pads are arranged and the supporting member may surround the plurality of charging pads on the charging surface.

According to an embodiment, a charging system includes an aerosol generating device including a first charging pin and a second charging pin spaced apart from the first charging pin by a first interval, a charging station on which a plurality of charging pads is arranged to be spaced apart from each other, and a controller configured to detect, among the plurality of charging pads, one charging pad to which the first charging pin is connected and another charging pad to which the second charging pin is connected, and supply power to the detected charging pads. In the charging station, two adjacent charging pads among the plurality of charging pads are spaced apart by a second interval that is less than or equal to the first interval.

In an embodiment, the aerosol generating device may include a charging port into which an external charging terminal is inserted and the first charging pin, the second charging pin, and the charging port may be formed on one surface of the aerosol generating device.

In an embodiment, the aerosol generating device may include a charging port for receiving an external charging terminal. The first charging pin and the second charging pin may be formed on one side of the aerosol generating device. The charging port may be formed on another side of the aerosol generating device.

In an embodiment, the first charging pin and the second charging pin may be compressible by a predetermined distance such that the first charging pin and the second charging pin are compressed by the aerosol generating device when the first charging pin and the second charging pin contact the plurality of charging pads.

### Effects

According to an embodiment, in a charging device and charging system, an aerosol generating device may be freely mounted and charged on a charging station, and thus, the charging convenience may be improved. For example, the charging station may reduce positional and connection constraints for charging and charge the aerosol generating device by contacting two charging pins of the aerosol generating device with any two charging pads among a plurality of charging pads.

According to an embodiment, a charging device and charging system may solve charging failure and improve charging efficiency through a structure in which two charging pins are properly positioned with two charging pads of a plurality of pads.

According to an embodiment, the effects of a charging device for an aerosol generating device and a charging system including the same may not be limited to the above-described effects, and other undescribed effects may be clearly understood from the following description by one of ordinary skill in the art.

### BRIEF DESCRIPTION OF DRAWINGS

FIG. 1 is a block diagram of an aerosol generating device according to an embodiment.

FIG. 2a is a perspective view of a charging system for the aerosol generating device according to an embodiment.

FIG. 2b is a block diagram of the charging system for the aerosol generating device according to an embodiment.

FIG. 3a is a cross-sectional view of the aerosol generating device and a charging station according to an embodiment.

FIG. 3b is a plan view of the charging station according to an embodiment.

FIG. 4 is a perspective view of the charging system for the aerosol generating device according to an embodiment.

FIG. 5 is a perspective view of the aerosol generating device according to an embodiment.

FIG. 6 is a perspective view of the aerosol generating device according to an embodiment.

### BEST MODE FOR CARRYING OUT THE INVENTION

The terms used in various embodiments are selected from among common terms that are currently widely used, in consideration of their function in the disclosure. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

As used herein, an expression such as “at least one of” that precedes listed components modifies not each of the listed components but all the listed components. For example, the expression “at least one of a, b, or c” should be construed as including a, b, c, a and b, a and c, b and c, or a, b, and c.

In various embodiments, the term “aerosol generating article” may refer to an article that accommodates a medium, in which an aerosol passes through the article and the medium is transferred. A representative example of the aerosol generating article may be a cigarette. However, the scope of the disclosure is not limited thereto.

In various embodiments, the terms “upstream” or “upstream direction” may refer to a direction away from the mouth of a user (smoker) and the terms “downstream” or “downstream direction” may refer to a direction toward the mouth of the user. The terms “upstream” and “downstream” may be used to describe relative positions of components of an aerosol generating article.

In various embodiments, the term “puff” refers to inhalation by a user and inhalation refers to a situation in which a user draws in an aerosol into their oral cavity, nasal cavity, or lungs through the mouth or nose.

In an embodiment, an aerosol generating device may be a device that generates an aerosol by electrically heating a cigarette accommodated in an inner space.

In an embodiment, the aerosol generating device may include a heater. In an embodiment, the heater may be an electrically resistive heater. For example, the heater may include an electrically conductive track, and the heater may be heated as a current flows through the electrically conductive track.

In an embodiment, the heater may include a tubular heating element, a plate-shaped heating element, a needle-shaped heating element, or a rod-shaped heating element and may heat the inside or outside of the cigarette according to the shape of a heating element.

In an embodiment, the cigarette may include a tobacco rod and a filter rod. The tobacco rod may be formed as a sheet or a strand, or may be formed of tobacco leaves finely cut from a tobacco sheet. In addition, the tobacco rod may be enveloped by a thermally conductive material. For example, the thermally conductive material may be a metal foil such as aluminum foil. However, embodiments are not limited thereto.

In an embodiment, the filter rod may be a cellulose acetate filter. The filter rod may include at least one segment. For example, the filter rod may include a first segment that cools an aerosol and a second segment that filters a predetermined ingredient contained in the aerosol.

In an embodiment, the aerosol generating device may be a device that generates an aerosol using a cartridge containing an aerosol generating material.

In an embodiment, the aerosol generating device may include a cartridge containing the aerosol generating material and a main body supporting the cartridge. The cartridge may be detachably coupled to the main body. However, embodiments are not limited thereto. The cartridge may be integrally formed or assembled with the main body and may be secured to the main body so as not to be detached by a user. The cartridge may be mounted on the main body while the aerosol generating material is accommodated therein. However, embodiments are not limited thereto. The aerosol generating material may be injected into the cartridge while the cartridge is coupled to the main body.

In an embodiment, the cartridge may hold the aerosol generating material having any one of various states, such as a liquid state, a solid state, a gaseous state, and a gel state. The aerosol generating material may include a liquid composition. For example, the liquid composition may be a liquid including a tobacco-containing material having a volatile tobacco flavor ingredient, or a liquid including a non-tobacco material.

In an embodiment, the cartridge may be operated by an electrical signal or a wireless signal transmitted from the main body to perform the function of generating an aerosol by converting the phase of the aerosol generating material inside the cartridge to a gaseous phase. The aerosol may refer to a gas in which vaporized particles generated from the aerosol generating material are mixed with air.

In various embodiments, the aerosol generating device may generate an aerosol by heating the liquid composition, and the generated aerosol may pass through the cigarette and be delivered to the user. That is, the aerosol generated from the liquid composition may travel along airflow paths of the aerosol generating device, and the airflow paths may be configured to allow the aerosol to pass through the cigarette and be delivered to the user.

In various embodiments, the aerosol generating device may be a device that generates an aerosol from the aerosol generating material using an ultrasonic vibration manner. In this case, the ultrasonic vibration manner may refer to a manner of generating an aerosol by atomizing the aerosol generating material with ultrasonic vibration generated by a vibrator.

In an embodiment, the aerosol generating device may include a vibrator and may generate vibration at short intervals through the vibrator to atomize the aerosol generating material. The vibration generated by the vibrator may be ultrasonic vibration, and the frequency band of the ultrasonic vibration may be from about 100 kHz to about 3.5 MHz. However, embodiments are not limited thereto.

In an embodiment, the aerosol generating device may further include a wick that absorbs the aerosol generating material. For example, the wick may be disposed to surround at least one area of the vibrator or may be disposed to contact at least one area of the vibrator.

In an embodiment, as a voltage (e.g., an alternating voltage) is applied to the vibrator, the vibrator may generate heat and/or ultrasonic vibration, and the heat and/or ultrasonic vibration generated by the vibrator may be transmitted to the aerosol generating material absorbed in the wick. The aerosol generating material absorbed in the wick may be converted into a gas phase by the heat and/or ultrasonic vibration transmitted from the vibrator, and consequently, an aerosol may be generated.

For example, the viscosity of the aerosol generating material absorbed in the wick may be lowered by the heat generated by the vibrator, and the aerosol generating material of which viscosity is lowered may be changed to fine particles by the ultrasonic vibration generated by the vibrator, so that an aerosol may be generated. However, embodiments are not limited thereto.

In various embodiments, the aerosol generating device may be a device that generates an aerosol by heating the aerosol generating article accommodated therein in an induction heating manner.

In an embodiment, the aerosol generating device may include a susceptor and a coil. In an embodiment, the coil may apply a magnetic field to the susceptor. As the aerosol generating device supplies power to the coil, a magnetic field may be formed inside the coil. In an embodiment, the susceptor may be a magnetic body that generates heat by an external magnetic field. As the susceptor is positioned inside the coil and generates heat with the magnetic field applied, the aerosol generating article may be heated. Also, optionally, the susceptor may be positioned in the aerosol generating article.

In various embodiments, the aerosol generating device may further include a cradle.

In an embodiment, the aerosol generating device and the separate cradle may form a system together. For example, the cradle may be used to charge a battery of the aerosol generating device. Alternatively, a heater may be heated when the cradle and the aerosol generating device are coupled to each other.

Hereinafter, embodiments of the disclosure will be described in detail with reference to the accompanying drawings such that one of ordinary skill in the art may easily practice the disclosure. The disclosure may be practiced in forms that are implementable in the aerosol generating devices according to various embodiments described above or may be embodied and practiced in many different forms and is not limited to the embodiments described herein.

Hereinafter, embodiments of the disclosure will be described in detail with reference to the drawings.

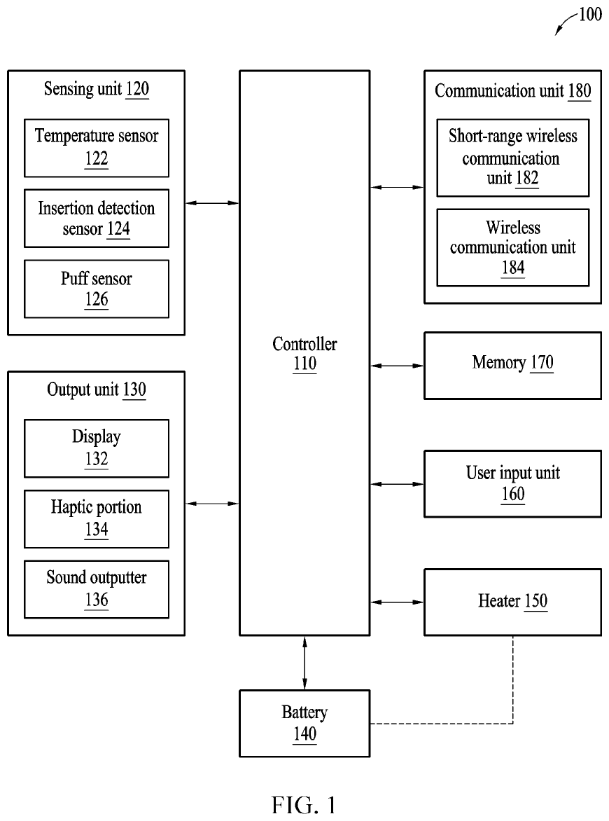

FIG. 1 is a block diagram of an aerosol generating device 100 according to an embodiment.

The aerosol generating device 100 may include a controller 110, a sensing unit 120, an output unit 130, a battery 140, a heater 150, a user input unit 160, a memory 170, and a communication unit 180. However, an internal structure of the aerosol generating device 100 is not limited to what is shown in FIG. 1. It is to be understood by one of ordinary skill in the art to which the disclosure pertains that some of the components shown in FIG. 1 may be omitted or new components may be added according to the design of the aerosol generating device 100.

In an embodiment, the sensing unit 120 may sense a state of the aerosol generating device 100 or a state of an environment around the aerosol generating device 100 and transmit sensing information obtained through the sensing to the controller 110. Based on the sensing information, the controller 110 may control the aerosol generating device 100 to control operations of the heater 150, restrict smoking, determine whether an aerosol generating article (e.g., an aerosol generating article, a cartridge, etc.) is inserted, display a notification, and perform other functions.

In an embodiment, the sensing unit 120 may include at least one of a temperature sensor 122, an insertion detection sensor 124, or a puff sensor 126. However, embodiments are not limited thereto.

In an embodiment, the temperature sensor 122 may sense a temperature at which the heater 150 (or an aerosol generating material) is heated. The aerosol generating device 100 may include a separate temperature sensor for sensing the temperature of the heater 150, or the heater 150 itself may function as a temperature sensor. Alternatively, the temperature sensor 122 may be arranged around the battery 140 to monitor the temperature of the battery 140.

In an embodiment, the insertion detection sensor 124 may sense whether the aerosol generating article is inserted and/or removed. The insertion detection sensor 124 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

In an embodiment, the puff sensor 126 may sense a puff from a user based on various physical changes in an airflow path or airflow channel. For example, the puff sensor 126 may sense the puff from the user based on any one of a temperature change, a flow change, a voltage change, and a pressure change.

In an embodiment, the sensing unit 120 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 122 through 126 described above. A function of each sensor may be intuitively inferable from its name by one of ordinary skill in the art, and thus, a more detailed description thereof will be omitted here.

In an embodiment, the output unit 130 may output information about the state of the aerosol generating device 100 and provide the information to the user. The output unit 130 may include at least one of a display 132, a haptic portion 134, or a sound outputter 136. However, embodiments are not limited thereto. When the display 132 and a touchpad are provided in a layered structure to form a touchscreen, the display 132 may be used as an input device in addition to an output device.

In an embodiment, the display 132 may visually provide information about the aerosol generating device 100 to the user. The information about the aerosol generating device 100 may include, for example, a charging/discharging state of the battery 140 of the aerosol generating device 100, a preheating state of the heater 150, an insertion/removal state of the aerosol generating article, a limited usage state (e.g., an abnormal article detected) of the aerosol generating device 100, or the like, and the display 132 may externally output the information. The display 132 may be, for example, a liquid-crystal display (LCD) panel, an organic light-emitting display (OLED) display, or the like. The display 132 may also be in the form of a light-emitting diode (LED) device.

In an embodiment, the haptic portion 134 may provide information about the aerosol generating device 100 to the user in a haptic way by converting an electrical signal into a mechanical stimulus or an electrical stimulus. The haptic portion 134 may include, for example, a motor, a piezoelectric element, or an electrical stimulation device.

In an embodiment, the sound outputter 136 may provide information about the aerosol generating device 100 to the user in an auditory way. For example, the sound outputter 136 may convert an electric signal into a sound signal and externally output the sound signal.

In an embodiment, the battery 140 may supply power to be used to operate the aerosol generating device 100. The battery 140 may supply power to heat the heater 150. In addition, the battery 140 may supply power required for operations of the other components (e.g., the sensing unit 120, the output unit 130, the user input unit 160, the memory 170, and the communication unit 180) included in the aerosol generating device 100. The battery 140 may be a rechargeable battery or a disposable battery. The battery 140 may be, for example, a lithium polymer (LiPoly) battery. However, embodiments are not limited thereto.

In an embodiment, the heater 150 may receive power from the battery 140 to heat the aerosol generating material. Although not shown in FIG. 1, the aerosol generating device 100 may further include a power conversion circuit (e.g., a direct current (DC)-to-DC (DC/DC) converter) that converts power of the battery 140 and supplies the power to the heater 150. In addition, when the aerosol generating device 100 generates an aerosol in an induction heating manner, the aerosol generating device 100 may further include a DC-to-alternating current (AC) (DC/AC) converter that converts DC power of the battery 140 into AC power.

In an embodiment, the controller 110, the sensing unit 120, the output unit 130, the user input unit 160, the memory 170, and the communication unit 180 may receive power from the battery 140 to perform functions. Although not shown in FIG. 1, the aerosol generating device 100 may further include a power conversion circuit, for example, a low dropout (LDO) circuit or a voltage regulator circuit, which converts power of the battery 140 and supplies the power to respective components.

In an embodiment, the heater 150 may be formed of a predetermined electrically resistive material that is suitable. For example, the electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 150 may be implemented as a metal heating wire, a metal heating plate on which an electrically conductive track is arranged, a ceramic heating element, or the like but is not limited thereto.

According to an embodiment, the heater 150 may be an induction heater. For example, the heater 150 may include a susceptor that heats the aerosol generating material by generating heat through a magnetic field applied by a coil.

In an embodiment, the heater 150 may include a plurality of heaters. For example, the heater 150 may include a first heater for heating the aerosol generating article and a second heater for heating a liquid.

In an embodiment, the user input unit 160 may receive information input from the user or may output information to the user. For example, the user input unit 160 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 1, the aerosol generating device 100 may further include a connection interface such as a universal serial bus (USB) interface and may be connected to another external device through the connection interface such as a USB interface to transmit and receive information or to charge the battery 140.

In an embodiment, the memory 170, which is hardware for storing various pieces of data processed by the aerosol generating device 100, may store data processed by the controller 110 and data to be processed thereby. The memory 170 may include at least one type of storage medium of a flash memory type memory, a hard disk type memory, a multimedia card micro type memory, a card type memory (e.g., an SD or XD memory), random access memory (RAM), static random access memory (SRAM), read-only memory (ROM), electrically erasable programmable read-only memory (EEPROM), programmable read-only memory (PROM), a magnetic memory, a magnetic disk, or an optical disk. The memory 170 may store an operating time of the aerosol generating device 100, the maximum number of puffs, the current number of puffs, at least one temperature profile, data associated with a smoking pattern of the user, or the like.

In an embodiment, the communication unit 180 may include at least one component for communicating with another electronic device. For example, the communication unit 180 may include a short-range wireless communication unit 182 and a wireless communication unit 184.

In an embodiment, the short-range wireless communication unit 182 may include a Bluetooth communication unit, a BLE communication unit, a near field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

In an embodiment, the wireless communication unit 184 may include, for example, a cellular network communicator, an Internet communicator, a computer network (e.g., a local area network (LAN) or a wide-area network (WAN)) communicator, or the like. However, embodiments are not limited thereto. The wireless communication unit 184 may use subscriber information (e.g., international mobile subscriber identity (IMSI)) to identify and authenticate the aerosol generating device 100 in a communication network.

In an embodiment, the controller 110 may control the overall operation of the aerosol generating device 100. In an embodiment, the controller 110 may include at least one processor. The processor may be implemented as an array of a plurality of logic gates or may be implemented as a combination of a general-purpose microprocessor and a memory in which a program executable by the microprocessor is stored. In addition, it is to be understood by those having ordinary skill in the art to which the disclosure pertains that it may be implemented in other types of hardware.

In an embodiment, the controller 110 may control the temperature of the heater 150 by controlling the supply of power from the battery 140 to the heater 150. For example, the controller 110 may control the supply of power by controlling switching of a switching element between the battery 140 and the heater 150. In another example, a direct heating circuit may control the supply of power to the heater 150 according to a control command from the controller 110.

In an embodiment, the controller 110 may analyze a sensing result obtained by the sensing of the sensing unit 120 and control processes to be performed thereafter. For example, the controller 110 may control power to be supplied to the heater 150 to start or end an operation of the heater 150 based on the sensing result obtained by the sensing unit 120. In another example, the controller 110 may control the amount of power to be supplied to the heater 150 and the time for which the power is to be supplied, such that the heater 150 may be heated up to a predetermined temperature or maintained at a desired temperature, based on the sensing result obtained by the sensing unit 120.

In an embodiment, the controller 110 may control the output unit 130 based on the sensing result obtained by the sensing unit 120. For example, when the number of puffs counted through the puff sensor 126 reaches a preset number, the controller 110 may inform the user that the aerosol generating device 100 is to be ended soon through at least one of the display 132, the haptic portion 134, or the sound outputter 136.

In an embodiment, the controller 110 may control the power supply time and/or the power supply amount for the heater 150 according to a state of the aerosol generating article sensed by the sensing unit 120. For example, when the aerosol generating article is in an over-humidified state, the controller 110 may control the power supply time for an inductive coil to increase a preheating time, compared to a case where the aerosol generating article is in a general state.

An embodiment may also be implemented in the form of a recording medium including instructions executable by a computer, such as a program module executable by the computer. A computer-readable medium may be any available medium that can be accessed by a computer and includes all of a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms and includes any information transfer medium.

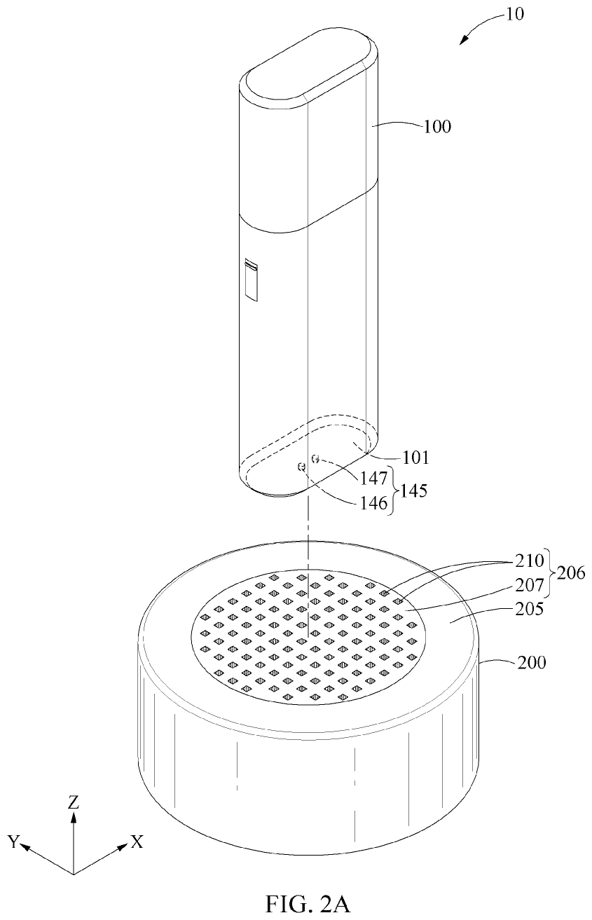

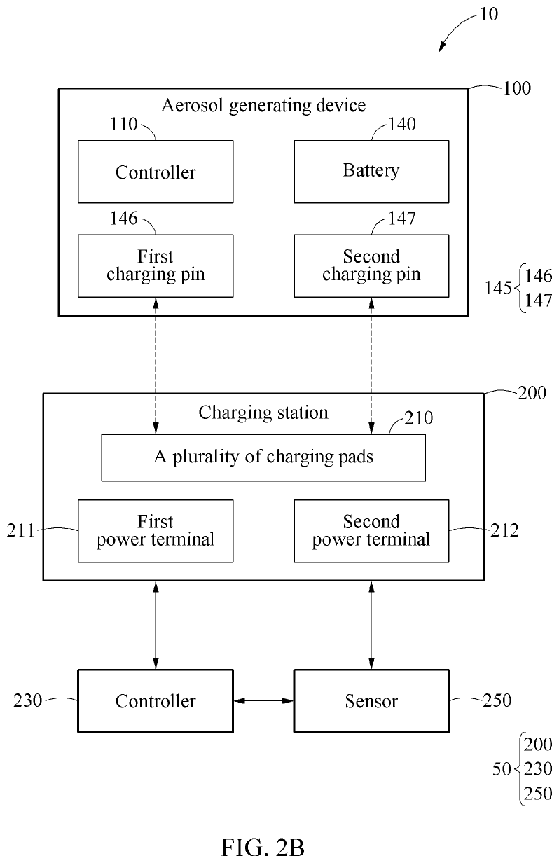

FIG. 2a is a perspective view of a charging system 10 for the aerosol generating device 100 according to an embodiment and FIG. 2b is a block diagram of the charging system 10 for the aerosol generating device 100 according to an embodiment.

Referring to FIGS. 2a and 2b, the charging system 10 may include a charging station 200 including a plurality of charging pads 210.

In an embodiment, the charging system 10 may refer to a system including an electronic device that performs a charging method for charging a battery (e.g., the battery 140 of FIG. 1) of the aerosol generating device 100.

In an embodiment, the charging system 10 may include a charging device 50 for charging the aerosol generating device 100. For example, the charging device 50 may include at least one of the charging station 200, a controller 230, and a sensor 250. For example, the charging device 50 may include the charging station 200 and the controller 230, without the sensor 250. In a case where the controller 230 (or the controller 230 and the sensor 250) is embedded in the charging station 200, the charging device 50 may be referred to as the charging station 200.

In an embodiment, the charging system 10 may include the charging device 50 and the aerosol generating device 100. Alternatively, in an embodiment, the charging system 10 may be the charging device 50 itself excluding the aerosol generating device 100. For example, the aerosol generating device 100 may correspond to an external device that is a target to be charged and may be excluded from a configuration of the charging system 10.

In an embodiment, the aerosol generating device 100 may include a plurality of charging pins 145. For example, the plurality of charging pins 145 may include a first charging pin 146 and a second charging pin 147. However, the embodiment is not limited thereto, and the plurality of charging pins 145 may be implemented as a plurality of inner pin structures arranged in one charging module (not shown) or may be implemented as three or more charging pins.

In an embodiment, the first charging pin 146 and the second charging pin 147 may be spaced apart from each other and formed on a first surface 101, which is one surface of the aerosol generating device 100.

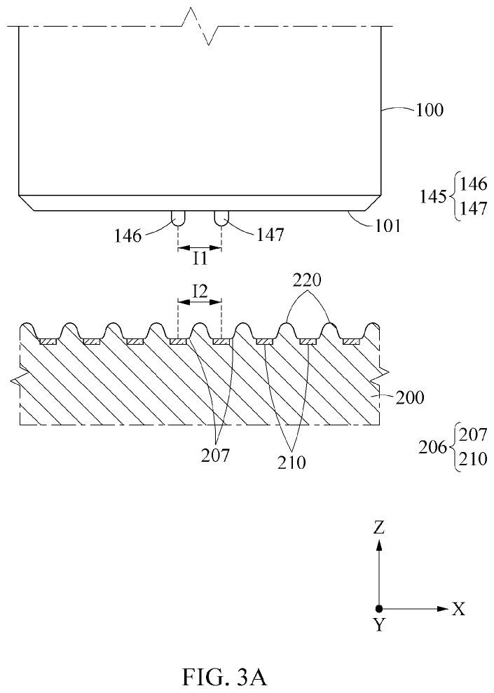

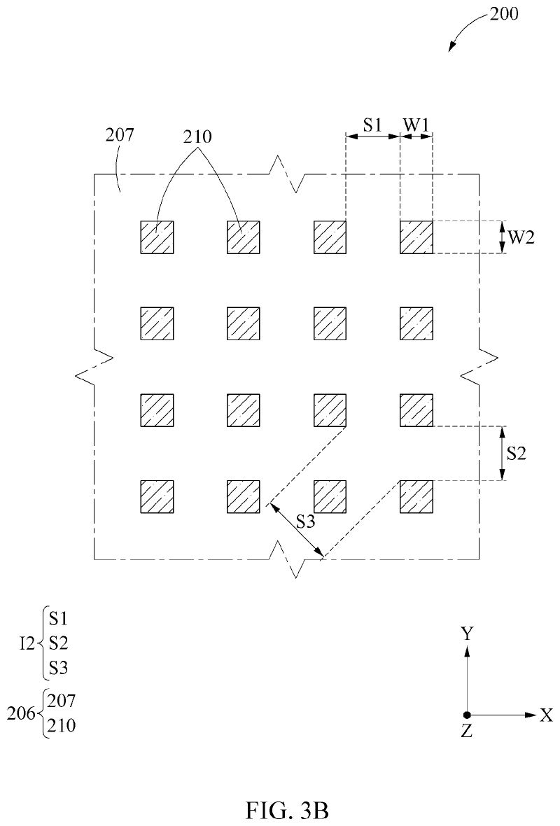

For example, the first charging pin 146 and the second charging pin 147 may be formed on the first surface 101 facing the downward direction (e.g., the −Z direction) of the aerosol generating device 100 and the second charging pin 147 may be spaced apart from the first charging pin 146 by a first interval (e.g., a first interval I1 of FIG. 3a).

In an embodiment, the first charging pin 146 and the second charging pin 147 may be made of a conductive member and may be electrically connected to the battery 140. For example, the first charging pin 146 may be a positive pin connected to a positive terminal of the battery 140. The second charging pin 147 may be a negative pin connected to a negative terminal of the battery 140. However, the embodiment is not limited thereto, and the first charging pin 146 may be a negative pin connected to the negative terminal of the battery 140 and the second charging pin 147 may be a positive pin connected to the positive terminal of the battery 140.

In an embodiment, a controller (e.g., the controller 140 of FIG. 1) may detect a contact state between the plurality of charging pins 145 and the plurality of charging pads 210 and may control power supplied through the plurality of charging pins 145 to the battery 140 and/or other components (e.g., the heater 150 of FIG. 1).

In an embodiment, the charging station 200 may charge the aerosol generating device 100 and/or may support the aerosol generating device 100. The charging station 200 may include a charging surface 205 that is one side facing an upward direction (e.g., the +Z direction) and the plurality of charging pads 210 disposed on the charging surface 205.

For convenience of understanding, FIG. 2a illustrates an embodiment where the charging station 200 simply includes the charging surface 205, but it is not limited thereto in actual implementation. In various embodiments, the charging station 200 may be implemented in various shapes and structures and may further include other components not shown in the drawings. For example, the charging station 200 may include an outlet (not shown) connected to an external power source. Also, the charging station 200 may include a display (not shown) or an indicating light (not shown) for displaying the state of charge or charging information.

In an embodiment, the plurality of charging pads 210 may be arranged to be spaced apart from each other on the charging surface 205 of the charging station 200. An insulating region 207 may be formed between the plurality of charging pads 210. The insulating region 207 may separate the plurality of charging pads 210. The insulating region 207 may be made of insulating material.

In an embodiment, the plurality of charging pads 210 may be arranged to be spaced apart at a predetermined interval on the charging surface 205. For example, two adjacent charging pads 210 among the plurality of charging pads 210 may be spaced apart at a second interval (e.g., the second interval I2 of FIG. 3a).

In an embodiment, as shown in FIG. 2a, each of the plurality of charging pads 210 may have a substantially rectangular shape and may be made of a conductor having a flat upper surface that is substantially coplanar with the charging surface 205. However, the embodiment is not limited thereto, and each of the plurality of charging pads 210 may have a circular or polygonal shape and may be curved or protrude from the charging surface 205. In various embodiments, the plurality of charging pads 210 may have the same shape and size, but embodiments are not limited thereto.

In an embodiment, when the aerosol generating device 100 is disposed on the charging station 200, one of the plurality of charging pads 210 may contact and be electrically connected to the first charging pin 146 and another of the plurality of charging pads 210 may contact and be electrically connected to the second charging pin 147.

In an embodiment, the plurality of charging pads 210 and the insulating region 207 may form a charging region 206. As shown in FIG. 2a, the charging region 206 in an embodiment may be a partial region of the charging surface 205. In another embodiment, the plurality of charging pads 210 and the insulating region 207 may extend to the substantially entire region of the charging surface 205, such that the charging region 206 occupies the entire region of the charging surface 205. As the charging surface 205 is widened, the charging region 206 in which the aerosol generating device 100 can be charged at any position may be expanded, and thus the charging convenience may be improved.

In an embodiment, the controller 230 may detect a connection between some of the plurality of charging pads 210 and the plurality of charging pins 145, and based on this, may supply power to some of the charging pads 210. For example, the controller 230 may detect the connection between some of the plurality charging pads 210 and the plurality of charging pins 145 in various ways, and may charge the aerosol generating device 100 by supplying power to the charging pad 210 connected to the plurality of charging pins 145.

In an embodiment, the sensor 250 may detect various pieces of information on the state of the charging station 200 and the aerosol generating device 100, and provide the detected information to the controller 230.

For example, the sensor 250 may detect whether the aerosol generating device 100 is mounted on the charging station 200. The sensor 250 may identify the charging pad 210 that is connected to the first charging pin 146 or the second charging pin 147, among the plurality of charging pads 210. The sensor 250 may obtain various pieces of information, such as the state of charge of the battery 140 of the aerosol generating device 100, the model of the aerosol generating device 100, etc., and provide the obtained information to the controller 230. The controller 230 may control the state of charge of the charging station 200 based on information provided from the sensor 250.

Hereinafter, some of the sensing operation and power supplying operation of the controller 230 is described as an example. However, in actual implementation, embodiments are not limited thereto, and may be modified or replaced in various ways that may be easily implemented by those skilled in the art.

In an embodiment, each of the plurality of charging pads 210 may be selectively connected to a first power terminal 211 and a second power terminal 212. The first power terminal 211 and the second power terminal 212 may be connected to the plurality of charging pads 210 through a switch (not shown). The controller 230 may control a switch (not shown) and power may be supplied or cut off by an operation of a switch (not shown).

In an embodiment, the controller 230 may connect the first power terminal 211 and the second power terminal 212 to the two charging pads 210 among the plurality of charging pads 210, respectively, such that power is supplied to the aerosol generating device 100 through the plurality of charging pins 145 connected to the two charging pads 210. In an embodiment, the first power terminal 211 may be a positive terminal and the second power terminal 212 may be a negative terminal. The first charging pin 146 may be a positive pin and the second charging pin 147 may be a negative pin.

In an embodiment, when one of the plurality of charging pads 210 is connected to the first charging pin 146, the controller 230 may electrically connect the charging pad connected to the charging pin 146 to the first power terminal 211, thereby limiting a connection between another charging pad and the first power terminal 211.

In an embodiment, when another charging pad 210 of the plurality of charging pads 210 is connected to the second charging pin 147, the controller 230 may electrically connect the charging pad 210 connected to the second charging pin 147 to the second power terminal 212, thereby limiting a connection between another charging pad and the second power terminal 212.

According to embodiments, the number and position of the charging pads 210 to which the first charging pin 146 and the second charging pin 147 are connected for charging the aerosol generating device 100 may be adjusted, such that the charging region 206 in which the aerosol generating device 100 can be charged at any position may be adjusted. In an embodiment, the aerosol generating device 100 may be easily charged when placed at any position within the charging region 206 of the charging station 200, without a need for the connection by a separate external connector.

Otherwise, if the plurality of charging pins 145 and the charging pads 210 of the aerosol generating device 100 correspond in a “one to one” (1:1) manner, the aerosol generating device 100 must be seated to contact the corresponding charging pad 210. Alternatively, an operation of connecting a separate connector to the aerosol generating device 100 may be required.

In various embodiments of the disclosure, in the charging system 10, the plurality of charging pins 145 and the charging pads 210 may correspond in a “one-to-many” (1:many) manner. In other words, the number of the charging pads 210 may be different from the number of charging pins 145. In the charging system 10, even if the aerosol generating device 100 is placed at any position on the charging region 206, only one of the plurality of charging pads 210 may correspondingly contact one charging pin 146 or 147. Thereby, the charging system 10 may charge the aerosol generating device 100.

FIG. 3a is a cross-sectional view of the aerosol generating device 100 and a charging station 200 according to an embodiment.

Referring to FIG. 3a, in an embodiment, the charging station 200 may include a guide member 220.

In an embodiment, the guide member 220 may be provided between the plurality of charging pads 210 and may be formed, for example, in the insulating region 207 of the charging region 206.

In an embodiment, the guide member 220 may be formed to protrude from a surface (e.g., the charging surface 205 or an X-Y plane) on which the plurality of charging pads 210 are arranged. For example, the guide member 220 may guide the plurality of charging pins 145 descending in the vertical direction (e.g., the Z-axis direction) to move in the lateral direction (e.g., the X-Y plane direction). For example, the guide member 220 may guide the first charging pin 146 or the second charging pin 147 to the adjacent charging pad 210.

In an embodiment, as shown in FIG. 3a, the guide member 220 may have a shape in which a cross-sectional area tapers off towards the end in a protruding direction (e.g., the +Z direction). Accordingly, the first charging pin 146 or the second charging pin 147 in contact with the guide member 220 may slide down and may be guided to the adjacent charging pad 210. For example, a cross-section of the guide member 220 in the lateral direction (e.g., the X-Z plane or the Y-Z plane) may have a substantially conical shape.

In an embodiment, the outer surface of the guide member 220 may have a curved shape with a predetermined curvature. For example, a cross-section of the guide member 220 taken in the lateral direction (e.g., along the X-Z plane or the Y-Z plane) may have a protrusion shape and may smoothly guide the first charging pin 146 or the second charging pin 147.

In an embodiment, at least a partial area of the guide member 220 may be made of insulating material. For example, an outer circumferential surface of the guide member 220 may be coated with insulating material or the guide member 220 may be made of insulating material.

In an embodiment, the guide member 220 may be integrally formed with the charging station 200 or the guide member 220 may be separately formed and then coupled with the charging station 200.

In an embodiment, at least a partial area of the guide member 220 may be made of a material having a lower friction coefficient than other areas such that the first charging pins 146 or the second charging pins 147 is guided to slide smoothly.

In an embodiment, the first charging pin 146 and the second charging pin 147 may be spaced apart at the first interval I1 and the plurality of charging pads 210 may be spaced apart at the second interval I2. In an embodiment, the first interval I1 may be a distance between the central axes of the first charging pin 146 and the second charging pin 147. The second interval I2 may be a distance between the centers of two adjacent charging pads 210 among the plurality of charging pads 210.

In an embodiment, the second interval I2 may be formed to be less than or equal to the first interval I1. For example, the second interval I2 may be substantially the same as the first interval I1 or the second interval I2 may be less than the first interval I1.

Otherwise, if the first interval I1 is less than the second interval I2, the first charging pin 146 and the second charging pin 147 may contact one charging pad 210. As another example, only one of the first charging pin 146 and the second charging pin 147 may contact the charging pad 210, while the other charging pin is caught on the guide member 220 or disposed in a region between the charging pad 210 and the guide member 220, thereby causing a charging failure. According to various embodiments of the disclosure, in the charging system 10, the second interval I2 may be formed to be less than or equal to the first interval I1 to prevent such a charging failure problem and to provide charging convenience.

FIG. 3b is a plan view of the charging station 200 according to an embodiment.

Referring to FIG. 3b, according to an embodiment, the plurality of charging pads 210 may be arranged in a matrix structure.

In an embodiment, the plurality of charging pads 210 may be spaced apart in a first direction (e.g., the X-axis direction) and a second direction (e.g., the Y-axis direction) perpendicular to the first direction, thereby being arranged in a matrix structure. However, the matrix structure of FIG. 3b is only an example arrangement structure for convenience of description. The plurality of charging pads 210 may be irregularly arranged in at least a partial area in actual implementation.

In an embodiment, each of the plurality of charging pads 210 may be formed in a plane structure having a first width W1 in the first direction and a second width W2 in the second direction. For example, when the plurality of charging pads 210 has a rectangular shape, each of the first width W1 and second width W2 may be lengths of sides in the first direction and second direction. Alternatively, when the plurality of charging pads 210 has polygonal, circular, or elliptical shapes, each of the first width W1 and the second width W2 may be distances between the two most distant points in the first direction and second direction.

In an embodiment, the second interval I2 may correspond to one of a first sub-interval S1, a second sub-interval S2, and a third sub-interval S3 according to a measuring direction.

In an embodiment, the first sub-interval S1 may be a distance between two charging pads 210 adjacent in the first direction. In an embodiment, the second sub-interval S2 may be a distance between two charging pads 210 adjacent in the second direction. In an embodiment, the third sub-interval S3 may be a distance between two charging pads 210 adjacent in the oblique direction (e.g., a direction between the first direction and second direction). In various embodiments, each of the first sub-interval S1, the second sub-interval S2, and the third sub-interval S3 may be formed to be less than or equal to the first interval I1.

In an embodiment, the sum of the first width W1 and the first sub-interval S1 may be formed to be less than or equal to the first interval I1. Otherwise, if the first interval I1 is less than the sum of the first width W1 and the first sub-interval S1, the first charging pin 146 and the second charging pin 147 may contact one charging pad 210. As another example, only one of the first charging pin 146 and the second charging pin 147 may contact the charging pad 210, while the other charging pin is caught on the guide member 220 or disposed in a region between the charging pad 210 and the guide member 220, thereby causing a charging failure. According to various embodiments of the disclosure, in the charging system 10, the sum of the first width W1 and the first sub-interval S1 may be formed to be less than or equal to the first interval I1 to prevent such a charging failure problem and to provide the charging convenience.

In an embodiment, the first width W1 and the second width W2 may be substantially the same and/or the first sub-interval S1 and the second sub-interval S2 may be substantially the same. In another embodiment, the first width W1 and the second width W2 may be different from each other, or the first sub-interval S1 and the second sub-interval S2 may be different from each other. In this case, the sum of the first width W1 and the first sub-interval S1 and the sum of the second width W2 and the second sub-interval S2 may be formed to be less than or equal to the first interval I1. Thus, the charging failure problem described above may be prevented and the charging convenience may be provided.

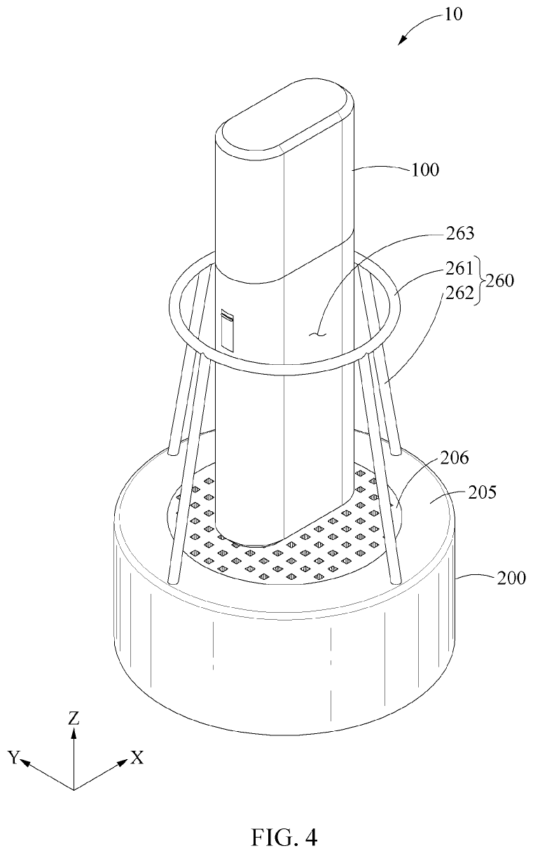

FIG. 4 is a perspective view of the charging system 10 for the aerosol generating device 100 according to an embodiment.

Referring to FIG. 4, in an embodiment, the charging station 200 may include a supporting member 260.

In an embodiment, the supporting member 260 may be formed to extend from the charging station 200 in the upward direction (e.g., the +Z direction) which the charging surface 205 faces. The supporting member 260 may support a side surface of the aerosol generating device 100.

As shown in FIG. 4, a first supporting region 261 and a second supporting region 262 are shown as a framework structure, but this is only shown simply for convenience of description, and various structures may be implemented in actual implementation. For example, the supporting member 260 may be a structure of a dome or cone shape in which an upper portion is open.

In an embodiment, the supporting member 260 may include the first supporting region 261 and the second supporting region 262. The first supporting region 261 may be formed to be spaced apart from the charging station 200 in the upward direction (e.g., the +Z direction) and may be a part for supporting a side surface of the aerosol generating device 100. The first supporting region 261 may have a circular or elliptical cross-sectional shape and may have an opening 263 formed at the center. The aerosol generating device 100 may pass through the opening 263.

In an embodiment, the second supporting region 262 may interconnect the first supporting region 261 and the charging station 200. The second supporting region 262 of the supporting member 260 may be disposed to surround the plurality of charging pads 210 on the charging surface 205.

In an embodiment, the supporting member 260 may guide the aerosol generating device 100 to an inserting position. The supporting member 260 may support the aerosol generating device 100 so as not to slip or deviate during charging. A user may easily charge the aerosol generating device 100 by simply inserting the aerosol generating device 100 into the opening 263 of the first supporting region 261, omitting the connection of a separate external connector.

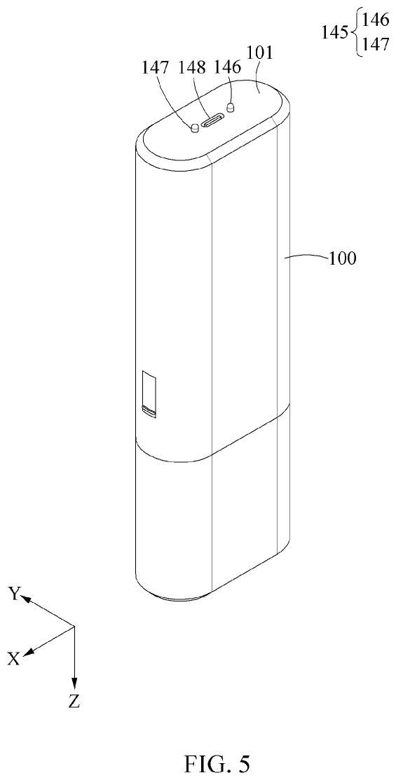

FIG. 5 is a perspective view of the aerosol generating device 100 according to an embodiment.

Referring to FIG. 5, according to an embodiment, the aerosol generating device 100 may include a charging port 148.

In an embodiment, the charging port 148 may be formed on the outer surface of the aerosol generating device 100. An external charging terminal (not shown) may be inserted into the charging port 148. The charging port 148 may be a groove structure into which an external charging terminal (not shown) is inserted.

In an embodiment, the charging port 148 may receive power through an external charging terminal (not shown) and transfer the supplied power to the battery 140 to charge the battery 140.

In an embodiment, in the aerosol generating device 100, the first charging pin 146, the second charging pin 147, and the charging port 148 may be formed on the same surface (e.g., the first surface 101). The aerosol generating device 100 may receive power through the plurality of charging pins 145 or the charging port 148 and may charge the battery 140.

In an embodiment, each of the first charging pin 146 and the second charging pin 147 may be compressible by a predetermined distance. When the first charging pin 146 and the second charging pin 147 contact the plurality of charging pads 210, the first charging pin 146 and the second charging pin 147 may be compressed by the aerosol generating device 100.

For example, the first charging pin 146 and the second charging pin 147 may be arranged by overlapping two common pillar structures and may be compressible in a way that one structure is compressed by an internal spring. Alternatively, the first charging pin 146 and the second charging pin 147 may be made of elastic material and compressible by a predetermined distance.

In an embodiment, when the first charging pin 146 or the second charging pin 147 is compressed, the compressed first charging pin 146 or the compressed second charging pin 147 may be electrically connected to the positive terminal or the negative terminal of the battery 140.

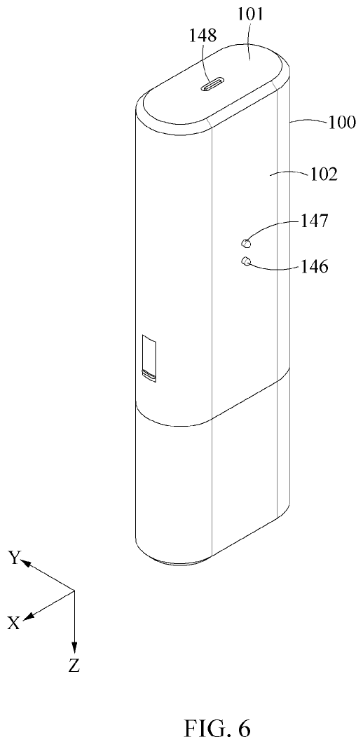

FIG. 6 is a perspective view of the aerosol generating device 100 according to an embodiment.

Referring to FIG. 6, according to an embodiment, the aerosol generating device 100 may include a second surface 102.

In an embodiment, the second surface 102 may be a surface different from the first surface 101 of the aerosol generating device 100. For example, the second surface 102 may be a side surface abutting the first surface 101 as shown in FIG. 6. In another embodiment, the second surface 102 may be on the opposite side of the first surface 101.

In an embodiment, the first charging pin 146 and the second charging pin 147 may be formed on the second surface 102. The aerosol generating device 100 may have a structure extending in a longitudinal direction (e.g., the Z-axis direction) which the first surface 101 faces. The center of gravity may be relatively lower and the aerosol generating device 100 may be stably mounted when the second surface 102 is mounted on the charging station 200 than when the first surface 101 is mounted on the charging station 200.

In an embodiment, the charging port 148 may be formed on the first surface 101 and the first charging pin 146 and the second charging pin 147 may be formed on the second surface 102. Since an external charging terminal (not shown) is connected to the charging port 148, the charging port 148 may be relatively more stable in a state in which the second surface 102 contacts a bottom surface.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other embodiments, and/or equivalents of the claims are within the scope of the following claims.

1. A charging device for an aerosol generating device comprising a first charging pin and a second charging pin spaced apart from the first charging pin by a first interval, the charging device comprising:
a charging station on which a plurality of charging pads are arranged to be spaced apart from each other; and
a controller configured to detect, among the plurality of charging pads, one charging pad to which the first charging pin is connected and another charging pad to which the second charging pin is connected, and supply power to the detected charging pads,
wherein two adjacent charging pads among the plurality of charging pads are spaced apart by a second interval that is less than or equal to the first interval.

2. The charging device of claim 1, wherein the plurality of charging pads are arranged in a matrix structure along a first direction and a second direction perpendicular to the first direction.

3. The charging device of claim 2, wherein each of the plurality of charging pads is formed in a planar structure having a first width in the first direction and a second width in the second direction.

4. The charging device of claim 3, wherein the second interval corresponds to one of a first sub-interval between two charging pads adjacent in the first direction and a second sub-interval between two charging pads adjacent in the second direction,
wherein a sum of the first width and the first sub-interval is less than or equal to the first interval.

5. The charging device of claim 4, wherein a sum of the second width and the second sub-interval is less than or equal to the first interval.

6. The charging device of claim 1, wherein the charging station comprises a guide member provided between the plurality of charging pads and configured to guide the first charging pin or the second charging pin to an adjacent charging pad.

7. The charging device of claim 6, wherein the guide member includes a plurality of protrusions spaced apart at a predetermined interval on a surface on which the plurality of charging pads are arranged.

8. The charging device of claim 7, wherein the guide member has a shape in which a cross-sectional area tapers off towards a protruding direction.

9. The charging device of claim 6, wherein at least a partial area of the guide member is made of an insulating material.

10. The charging device of claim 1, wherein the charging station comprises a supporting member configured to support a side surface of the aerosol generating device.

11. The charging device of claim 10, wherein
the charging station comprises a charging surface on which the plurality of charging pads are arranged, and
the supporting member surrounds the plurality of charging pads on the charging surface.

12. A charging system comprising:
an aerosol generating device comprising a first charging pin and a second charging pin spaced apart from the first charging pin by a first interval;
a charging station on which a plurality of charging pads is arranged to be spaced apart from each other; and
a controller configured to detect, among the plurality of charging pads, one charging pad to which the first charging pin is connected and another charging pad to which the second charging pin is connected, and supply power to the detected charging pads,
wherein two adjacent charging pads among the plurality of charging pads are spaced apart by a second interval that is less than or equal to the first interval.

13. The charging system of claim 12, wherein the aerosol generating device comprises a charging port for receiving an external charging terminal,
wherein the first charging pin, the second charging pin, and the charging port are formed on a same surface of the aerosol generating device.

14. The charging system of claim 12, wherein
the aerosol generating device comprises a charging port for receiving an external charging terminal,
the first charging pin and the second charging pin are formed on one side of the aerosol generating device, and
the charging port is formed on another side of the aerosol generating device.

15. The charging system of claim 12, wherein
the first charging pin and the second charging pin are compressible by a predetermined distance, and
the first charging pin and the second charging pin are compressed by the aerosol generating device when the first charging pin and the second charging pin contact the plurality of charging pads.
